(19) United States
(12) Patent Application Publication
(10) Pub. No.: US 2023/0132622 A1
(43) Pub. Date: May 4, 2023

(54) GREYWATER TREATMENT SYSTEM

(71) Applicant: WAHASO - WATER HARVESTING SOLUTIONS, Hinsdale, IL (US)

(72) Inventor: Stuart Bailin, Hinsdale, IL (US)

(21) Appl. No.: 17/507,391

(22) Filed: Oct. 21, 2021

(51) Int. Cl. C02F 9/00; C02F 1/00; C02F 1/32; B01D 61/14; B01D 61/18; B01D 61/20; B01D 65/02; B01D 29/66

(52) U.S. Cl. CPC C02F 9/005; B01D 29/66; B01D 61/18; B01D 61/20; B01D 61/142; B01D 65/02; C02F 1/001; C02F 1/32; B01D 2315/10; B01D 2315/20; B01D 2317/02; B01D 2317/04; B01D 2317/06; B01D 2321/04; B01D 2321/40; B01D 2321/164; C02F 2103/002; C02F 2201/005; C02F 2201/007

(57) ABSTRACT

A greywater treatment system includes a first modular greywater processing apparatus having a raw greywater inlet, a mechanical (MTF) filter connected to the raw greywater inlet, a first ultrafine (UF) filter connected in series downstream of the mechanical filter. The UF filter includes a UF filter inlet, a filtrate outlet, and a cross-flow outlet. The filtrate outlet is connected to a processed water outlet. A modular base supports the mechanical filter and the UF filter.

### FIELD OF THE DISCLOSURE

The disclosure relates to greywater treatment systems and more specifically to modular greywater treatment systems including two-stage filtration.

### BACKGROUND

As human population increases, ever greater demands are being put on natural resources. Food production and energy production systems are being taxed, resulting in food and power shortages. Another natural resource that is becoming scarce is safe fresh water. Water shortages have been experienced worldwide in recent years as population centers exhaust their supplies of fresh water. Water shortages have a destabilizing effect on local economies and may even lead to national or international conflicts.

Approximately 80% of the world’s population lives in areas having vulnerable water supplies. Excessive human water use can detrimentally affect wildlife, such as migrating fish, and can cause depletion of fresh water sources. Furthermore, dense population centers require extensive water delivery infrastructure. Good management of fresh water resources can protect wildlife while increasing water security.

Increases in population can result in water crises during droughts when water demand exceeds natural water replenishment of fresh water supplies. Generally, rainfall comes from complicated internal processes in the atmosphere that are very hard to predict. As population increases, naturally occurring periods of lower rainfall may result in water shortages as demand exceeds supply.

Although an overwhelming majority of the planet surface is composed of water, 97% of this water is saltwater. The fresh water used to sustain humans is only 3% of the total amount of water on Earth’s surface. Therefore, there is a limited supply of fresh water, which is stored in aquifers, in surface reservoirs and in the atmosphere. While seawater may be desalinated to render the water potable or useable by humans, only a very small fraction of the world’s water supply derives from desalination because desalination is an expensive, energy intensive process.

Fresh water supplies may be better managed through conservation efforts, such as water reclamation and water recycling. In some cases, demand on fresh water supplies may be reduced by reclaiming water that would otherwise go unused. One reclamation process is collecting rainwater in containers and storing the collected rainwater for later use. Water recycling, on the other hand, may be used by virtually any population, even those located in areas that receive little rainfall. Water recycling includes reusing or repurposing water that is used during human activities.

Generally, daily human water use produces two categories of wastewater, which are known as “greywater” and “blackwater.” Blackwater is wastewater that includes biological waste, such as feces and urine or is water heavily loaded with other contaminants such as food waste or wash water discharge from the wash cycle of a clothes washing machine. Blackwater is produced by toilets and other human waste collectors and requires extensive treatment before being released back into the environment due to its high organic content, dissolved solids, and contamination by various pathogens. Greywater, which is generated from domestic activities such as the rinse cycle of clothes washing machines, lavatory use, and bathing, requires less treatment as greywater generally contains fewer organic compounds than blackwater and generally includes less pathogen contamination. Greywater is produced by lavatory sinks, showers, the rinse cycle of clothes washing machines, and some industrial light use processes, etc.

Greywater may be used for many purposes that would otherwise use fresh, potable water. For example, greywater may be used for flushing toilets and irrigating outdoor plants. Using treated greywater to flush toilets, for example, instead of using fresh, potable water, can reduce the daily use of fresh, potable water by up to 30% in a typical family home.

As demands for potable water increase, communities will rely more heavily on water conservation efforts that include water recycling. Greywater recycling may become a key component of a water recycling system. In fact, some governments are incentivizing water conservation efforts by legislating tax breaks for programs that result in a reduction in fresh potable water usage from the community water supply. Recycling or repurposing greywater is often one component of such programs.

Current greywater recovery systems are generally limited to repurposing untreated greywater for irrigation purposes. Such systems are relatively simple, only requiring a separation of the greywater from the blackwater before the two are mixed. Then, the greywater is diverted outside for irrigation. These systems require that any irrigation be done through subsurface methods to minimize risks to public health and such systems are generally prohibited from storing greywater for extended periods. Most current greywater recovery systems do not treat greywater for indoor reuse.

Untreated greywater is heavily regulated by local health regulations, which generally restrict the uses for untreated greywater due to potential public health issues. In many localities, contact of untreated greywater with humans is prohibited and thus, using untreated greywater for indoor or above ground irrigation use is not currently allowed in most countries.

### SUMMARY

According to a first embodiment, a greywater treatment system includes a first modular greywater processing apparatus having a raw greywater inlet, a mechanical (MTF) filter connected to the raw greywater inlet, and a first ultrafine (UF) filter connected in series downstream of the mechanical filter. The UF filter includes a UF filter inlet, a filtrate outlet, and a cross-flow outlet. The filtrate outlet is connected to a processed water outlet. A modular base supports the mechanical filter and the UF filter.

The foregoing first embodiment of a greywater treatment system may further include any one or more of the following optional features, structures, and/or forms.

In some optional forms, a second UF filter is connected in parallel with the first UF filter, and in series with mechanical filter.

In some optional forms, the mechanical filter filters out particulate matter 200 microns or larger.

In some optional forms, the mechanical filter includes a backwash outlet that is adapted to be fluidly connected to a sewer.

In some optional forms, a differential pressure monitor is connected to the mechanical filter.

In some optional forms, a first control valve is disposed between mechanical filter and the UF filter.

In some optional forms, the filtrate outlet is fluidly connected to a processed water holding tank.

In some optional forms, the cross-flow outlet is fluidly connected to a raw greywater tank.

In some optional forms, an ultraviolet (UV) sterilizer is disposed downstream of the UF filter.

In some optional forms, a backwash line is disposed between the UV sterilizer and the UF filter.

In some optional forms, the UF filter removes particulates 0.02 microns and larger.

In some optional forms, a first backwash valve is disposed downstream of the UF filtrate outlet.

In some optional forms, a first control valve is disposed between the MTF filter and the UF filter.

In some optional forms, a second control valve is disposed downstream of the UF filtrate outlet.

In some optional forms, a third control valve is disposed between the UV sterilizer and the UF filtrate outlet.

In some optional forms, a second modular greywater processing apparatus is operatively connected to the first modular greywater processing apparatus.

In some optional forms, the second modular greywater processing apparatus includes a third UF filter connected in parallel to a fourth UF filter, both the third UF filter and the fourth UF filter being connected in series to the mechanical filter.

In some optional forms, a third modular greywater processing apparatus is operatively connected to the second modular greywater processing apparatus.

In some optional forms, the third modular greywater processing apparatus includes a fifth UF filter connected in parallel to a sixth UF filter, both the fifth UF filter and the sixth UF filter being connected in series to the mechanical filter.

In some optional forms, a chemical backwash system is fluidly connected to the UF filter.

In some optional forms, the chemical backwash system comprises a mixing tank and a chemical supply.

In some optional forms, the chemical backwash system further comprises a mixing venturi upstream of a chemical supply inlet.

In some optional forms, the mixing tank comprises a processed greywater inlet.

According to a second embodiment, a method of operating a greywater treatment system includes backwashing an MTF filter and a UF filter based on a zero flow reading from a flow sensor for a minimum period of time, and emptying raw greywater from a raw greywater tank.

The foregoing second embodiment of a method of operating a greywater treatment system may further include any one or more of the following optional features, structures, and/or forms.

In some optional forms, the minimum period of time is between 16 and 24 hours, preferably about 18 hours.

In some optional forms, the flow sensor is disposed downstream of the UF filter.

In some optional forms, the UF filter is continuously cleaned with a crossflow circuit and the waste from the crossflow circuit is returned to the raw greywater tank or to a sewer.

In some optional forms, the UF filter is backwashed based on a minimum flow input from the flow sensor.

In some optional forms, the minimum flow reading is between 1000 gallons of processed water and 3000 gallons of processed water, preferably between 1500 gallons of processed water and 2500 gallons of processed water, and more preferably at approximately 2000 gallons of processed water.

In some optional forms, the MTF filter is backwashed based on one of a maximum differential pressure input from a pressure sensor and a minimum flow input from the flow sensor.

In some optional forms, the maximum differential pressure is between 0 psi and 10 psi.

In some optional forms, the minimum flow input is between 35 gallons per minute and 80 gallons per minute

In some optional forms, the UF filter is chemically backwashed with a high pH solution based on a minimum flow input from the flow sensor.

In some optional forms, the minimum flow input for the chemical backwash is between 30,000 gallons of processed water and 50,000 gallons of processed water, preferably about 40,000 gallons of processed water.

In some optional forms, a processed water backwash is completed after the chemical backwash.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a perspective view of a first modular greywater processing apparatus.

FIG. 2 is front planar view of the modular greywater processing apparatus of FIG. 1.

FIG. 3 is rear planar view of the modular greywater processing apparatus of FIG. 1.

FIG. 4 is a first side view of the modular greywater processing apparatus of FIG. 1.

FIG. 5 is a second side view of the modular greywater processing apparatus of FIG. 1

FIG. 6 is a schematic illustration of a greywater treatment system including the modular greywater processing apparatus of FIG. 1.

FIG. 7 is a schematic illustration of the modular greywater processing apparatus of FIGS. 1 and 6.

FIG. 8 is a schematic illustration of a raw greywater holding tank of the greywater treatment system of FIG. 6.

FIG. 9 is a schematic illustration of a chemical backwash supply module of the greywater treatment system of FIG. 6.

FIG. 10 is a schematic illustration of an ultraviolet treatment module of the greywater treatment system of FIG. 6.

FIG. 11 is a schematic illustration of a processed water holding tank of the greywater treatment system of FIG. 6.

FIG. 12 is a perspective view of an alternate embodiment of a modular greywater processing apparatus having a second UF filter.

FIG. 13 is a perspective view of two alternate modular greywater processing apparatus of FIG. 12 connected to one another in parallel.

FIG. 14 is a perspective view of three alternate greywater processing apparatus of FIG. 12 connected to one another in parallel.

### DETAILED DESCRIPTION

The disclosed greywater treatment systems generally collect greywater from a greywater source, such as sinks, showers, or the rinse cycle of clothes washing machines, the systems then treat and store the greywater and distribute the treated greywater for reuse. The treated greywater may be used indoors, for example, to flush toilets, thereby reducing consumption of potable fresh water. The treated greywater may be used for other purposes, such as for water in clothes washing machines, or for above-ground spray irrigation systems, and some light industrial processes.

The benefits of collecting or harvesting greywater, treating the collected greywater, and reusing the treated greywater go far beyond fulfilling a desire to be “green.” Collecting, treating, and reusing greywater can have lasting economic benefits for building owners and for communities in general. By reusing treated greywater to flush toilets or urinals, to irrigate landscaping, or to support other water-intensive operations, municipal water charges can be significantly reduced. Wastewater treatment fees and environmental impact fees can also be reduced. Additionally, large scale reuse of greywater may stretch supplies of potable freshwater for communities, which extends the natural resource of water while simultaneously reducing individual water costs.

In high density buildings, the greywater treatment and reuse systems advantageously provide a relatively constant supply of treated greywater for flushing toilets. In some cases, the supply of treated greywater can meet 100% of toilet flushing requirements for a particular building. Because the disclosed greywater collection and treatment system provide a supply of greywater that is steady and predictable, storage requirements are reduced, saving storage space and cost. In other words, the predictable nature of greywater production in high density buildings allows the disclosed greywater treatment and reuse systems to be tailored in capacity for a particular building so that the supply of treated greywater generated by the greywater treatment and reuse systems closely match the demand for treated greywater (i.e., so that supply virtually matches demand), which reduces the need for extended storage of the treated greywater. Other uses for treated greywater include makeup water for evaporative cooling towers.

Greywater (also referred to as grey water, gray water and greywater), as used herein, refers to water that is produced by human domestic operations and that does not include significant concentrations of human biological waste (i.e., urine and feces) or food waste. Greywater is generally produced by sinks, showers, baths and light industrial applications, such as the rinse cycle of clothes washing machines and, and has not yet been treated (e.g., filtered and/or chemically treated) for pathogens.

When properly filtered and stored, greywater can be a valuable source of water to flush toilets, to flush urinals, or to irrigate landscaping. Toilet flushes can account for 25-65% or more of the total water use in a commercial building, even when low-flush fixtures are used.

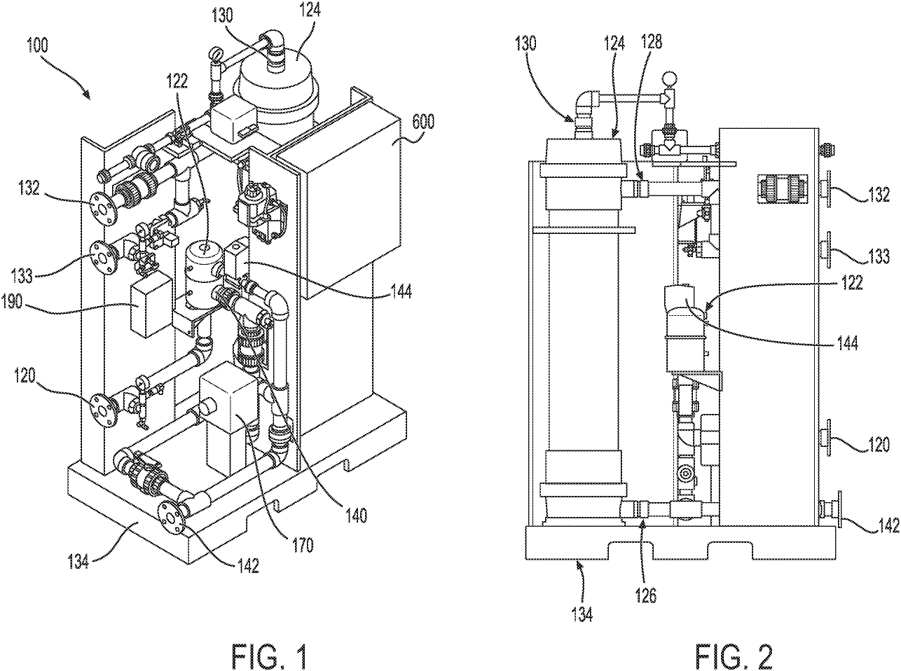

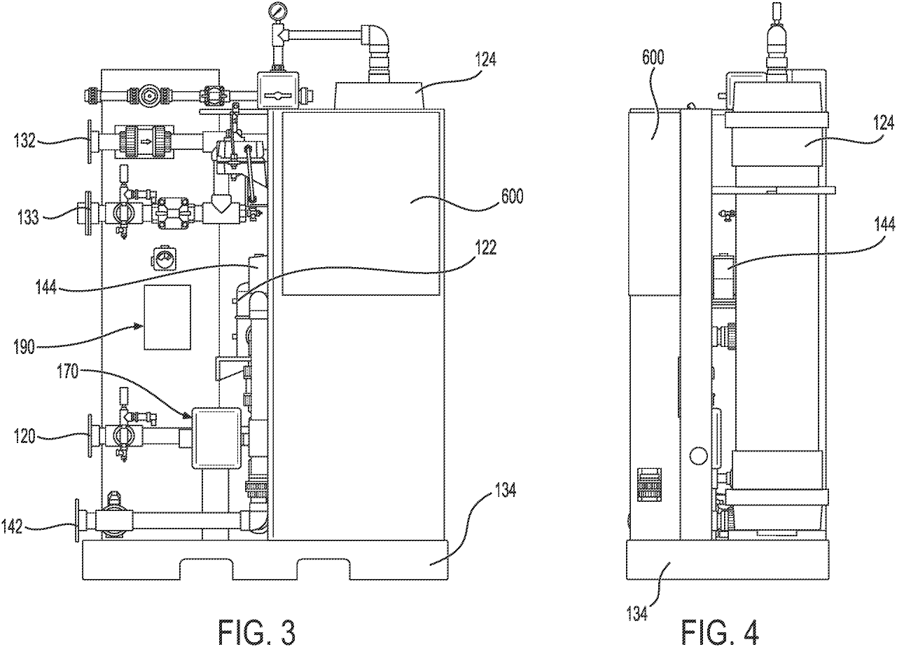

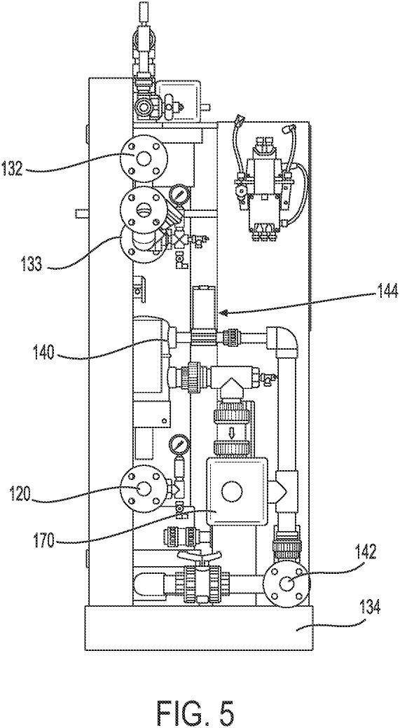

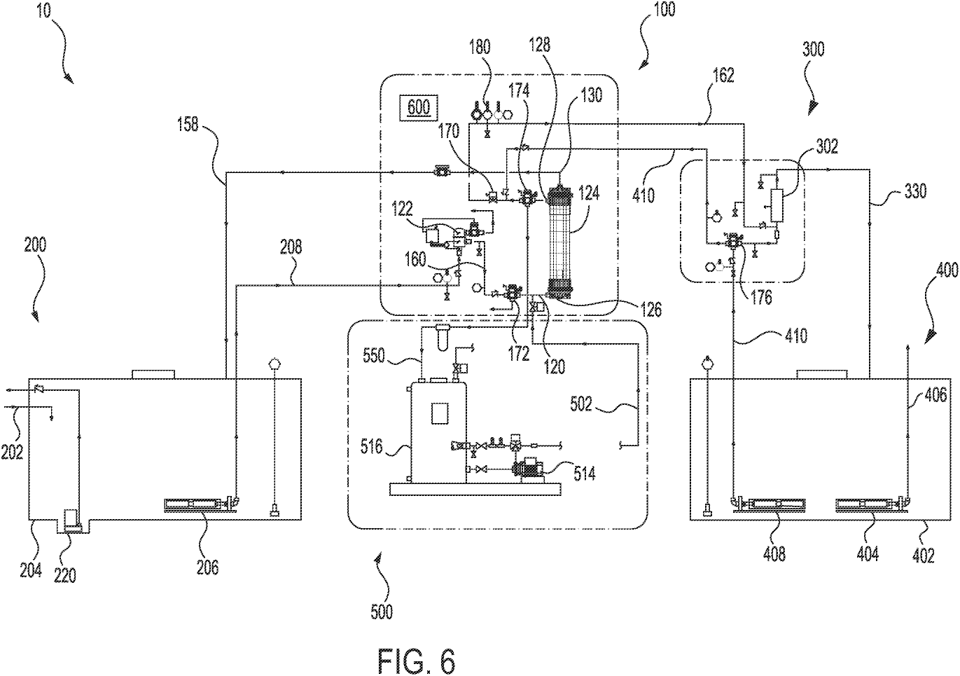

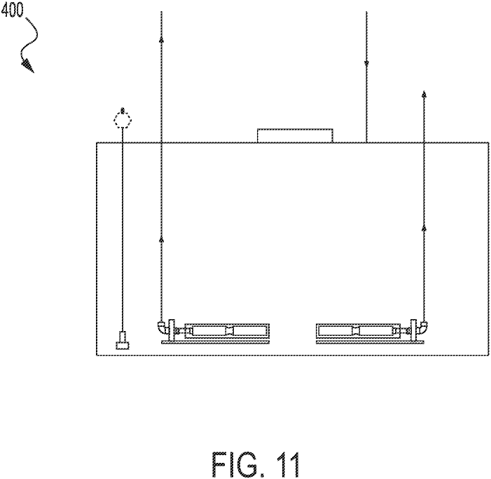

Turning now to FIGS. 1-5 a first modular greywater processing apparatus 100 is illustrated. The first modular greywater processing apparatus 100 may be incorporated into a greywater treatment system 10 (not fully illustrated in FIGS. 1-5, but schematically illustrated in FIG. 6), which will be discussed further below with respect to FIGS. 6-11. The first modular greywater processing apparatus 100 comprises a raw greywater inlet 120 that is fluidly connected to a mechanical (MTF) filter 122. A first ultrafine (UF) filter 124 is fluidly connected in series downstream of the mechanical filter 122. The UF filter 124 includes a UF filter inlet 126, a filtrate outlet 128, and a cross-flow outlet 130. The filtrate outlet 128 is connected to a processed water outlet 132. A backwash inlet 133 is connected to the filtrate outlet 128 for use during backwash (cleaning) operations. A modular base, such as a skid 134, supports the MTF filter 122 and the UF filter 124.

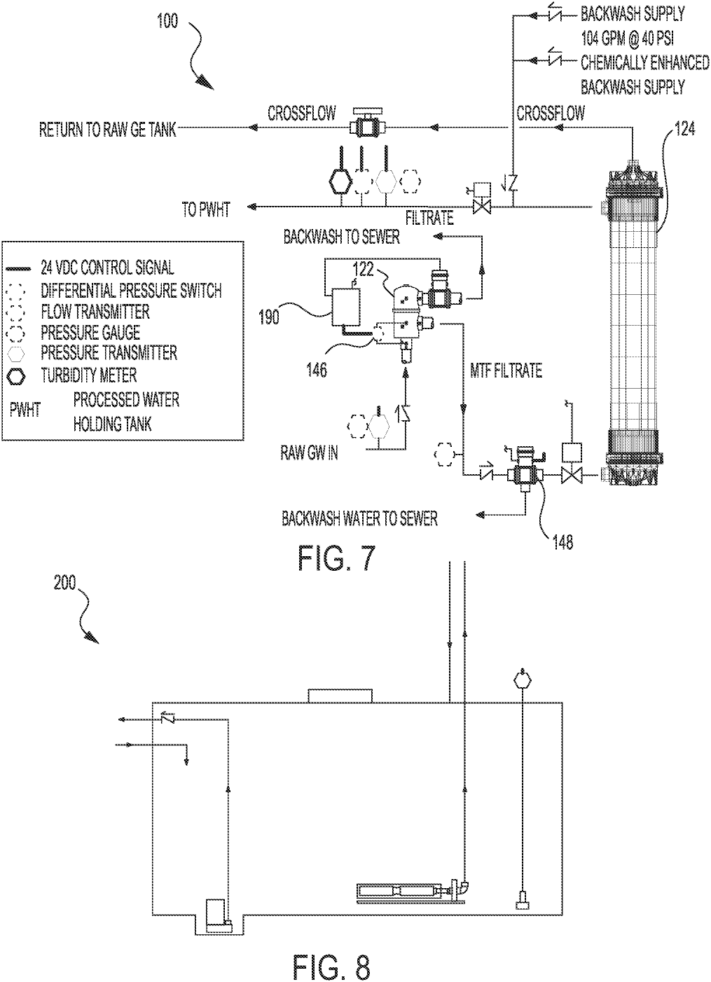

The MTF filter 122 is a self-cleaning mechanical filter that captures relatively large particulates in the greywater stream. The MTF filter 122 captures particulates larger that about 200 microns, such as lint, hair, and other large debris. The MTF filter 122 includes a backwash outlet 140 that is adapted to be fluidly connected to a sewer (or to a raw greywater holding tank) by a wastewater outlet 142 so that backwash water may be directed to the sewer after a backwash cleaning cycle. A backwash valve 144 opens to allow backwash water to flow to the wastewater outlet 142 during the backwash cycle, which will be discussed further below. A differential pressure monitor 146 (FIG. 7) is fluidly connected to the MTF filter 122 and the differential pressure monitor 146 measures differential pressure across the MTF filter 122 and sends the measurements to a MTF controller 190. The MTF controller 190 uses the differential pressure measurements to determine if the MTF filter 122 needs to be cleaned through a backwash cycle as the differential pressure across the MTF filter 122 is an indication of a saturation level of the MTF filter 122 with filtered particulates. The MTF filter 122 may be backwashed based on a time interval, or based on the measurements from the differential pressure monitor 146. In some embodiments, the maximum differential pressure is between 0 psi and 10 psi, preferably between 3 psi and 10 psi, and more preferably between 5 psi and 9 psi. In some embodiments, the minimum flow input is between 35 gpm and 80 gpm, preferably between 45 gpm and 70 gpm per membrane.

A first backwash valve 170 is disposed between the MTF filter 122 and the UF filter 124. The first backwash valve 170 directs backwash water from the MTF filter 122 to the wastewater outlet 142 during a backwash cycle.

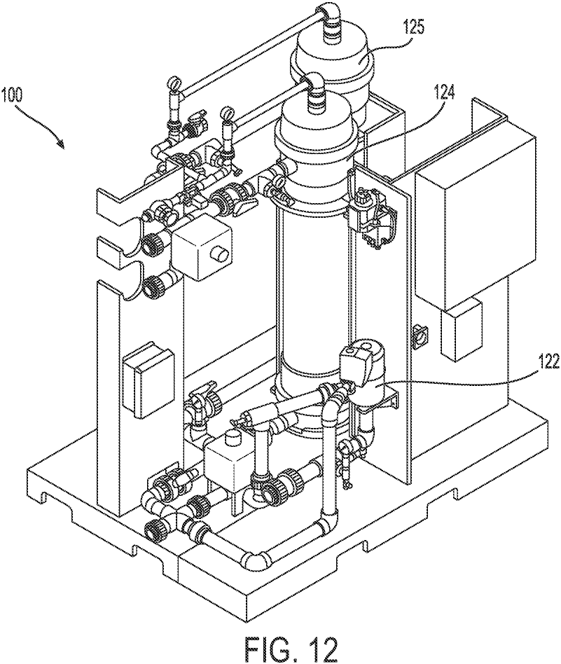

The UF filter 124 is an ultrafine membrane filter with a cross-flow cleaning circuit. The ultrafine membrane filter comprises both flat sheet and capillary membranes. The UF filter 124 removes particulates 0.02 microns and larger, which includes pathogens (such as bacteria and viruses) and suspended solids. In some embodiments, a second UF filter 125 may be connected in parallel with the first UF filter 124 and in series with the MTF filter 122, as illustrated in FIG. 12. The UF filter 124 may be continuously cleaned by a crossflow circuit and waste from the crossflow circuit may be returned to a raw greywater tank or to a sewer.

Turning now to FIG. 6, a greywater treatment system 10 is illustrated that includes the modular greywater processing apparatus 100 if FIGS. 1-5 (or of FIG. 12). The greywater treatment system 10 comprises a raw greywater holding tank 200 fluidly connected to the modular greywater processing apparatus 100 so that raw greywater may be pumped from the raw greywater holding tank 200 to the modular greywater processing apparatus 100. After filtering in the modular greywater processing apparatus 100, the filtered greywater is pumped to an ultraviolet (UV) sterilization unit 300 that is downstream of the UF filter 124. After sterilization in the UV sterilization unit 300, the sterilized greywater is pumped to a processed greywater holding tank 400. A chemical backwash unit 500 supplies chemical backwash fluid to the modular greywater processing apparatus 100 at regular intervals (or on demand) to clean the MTF filter 122 and the UF filter 124.

The raw greywater holding hank 200 is fluidly connected to sources of greywater, such as plumbing fixtures, washing machines, etc., by a raw greywater inlet line 202, which directs raw greywater into a raw greywater tank body 204. The raw greywater tank body 204 includes a raw greywater pump 206 that pumps raw greywater out of the raw greywater tank body 204 through a raw greywater output line 208, which leads to the MTF filter 122. The cross-flow outlet 130 from the UF filter 124 is connected to an internal cross-flow circuit (not shown) that continuously removes loading from the membrane and returns the loading to the raw greywater holding tank 202 through a cross-flow line 158.

From the MTF filter 122, the filtered greywater flows to the UF filter 124 through a mechanical filtrate line 160. After passing through the UF filter 124, the filtered greywater exits the UF filter 124 through a filtrate line 162 to a UV sterilizer 302. After sterilization in the UV sterilizer 302, the sterilized greywater is directed to a processed water tank body 402 in the processed water holding tank 400. In embodiments without a UV sterilizer 302, the filtrate outlet 132 may be directly fluidly connected to the processed water holding tank 400. A processed water pump 404 pumps the processed water from the processed water tank body 402 to downstream users of the processed water through a processed water exit line 406.

A processed backwash pump 408, which is activated during a standard backwash cycle, pumps processed water through backwash line 410, part of which connects the UF filter 124 to the UV sterilizer 302, to clean the UF filter 124, the MTF filter 122, and the UV sterilizer 302 during a standard backwash cycle. Generally, the standard backwash cycle is initiated after about 2000 gallons of greywater have been processed by the UF filter 124, although in other embodiments, other thresholds of processed greywater may be used to initiate the standard backwash cycle. The standard backwash cycle may also be initiated as a function of differential pressure across the MTF filter 122.

When more thorough cleaning is needed, the chemical backwash unit 500 supplies a chemically enhanced cleaning solution (normally a high pH solution) through a cleaning line 502 to the UF filter 124 during a chemical backwash cycle. The chemical backwash cycle is normally initiated after about 40,000 gallons of greywater have been processed by the UF filter 124, although in other embodiments, other thresholds of processed greywater may be used to initiate the chemical backwash cycle.

The backwash operations are controlled by the first backwash valve 170 disposed downstream of the UF filtrate outlet 128, a first control valve 172 disposed upstream of the raw greywater inlet 120, a second control valve 174 disposed downstream of the UF filtrate outlet 128, and upstream of the first backwash valve 170, and a third control valve 176 disposed between the UV treatment apparatus 302 and the UF filtrate outlet 128. The first, second, and third control valves 172, 174, 176, in the illustrated embodiment, are three-way motorized valves. The first backwash valve 170, in the illustrated embodiment, is a solenoid valve.

In the embodiments illustrated in FIGS. 12-14, the description of the UF filter 124 in the paragraphs above applies equally to any UF filter described below. Any feature of the UF filter 124 in the paragraphs above may equally be incorporated in the UF filters described below.

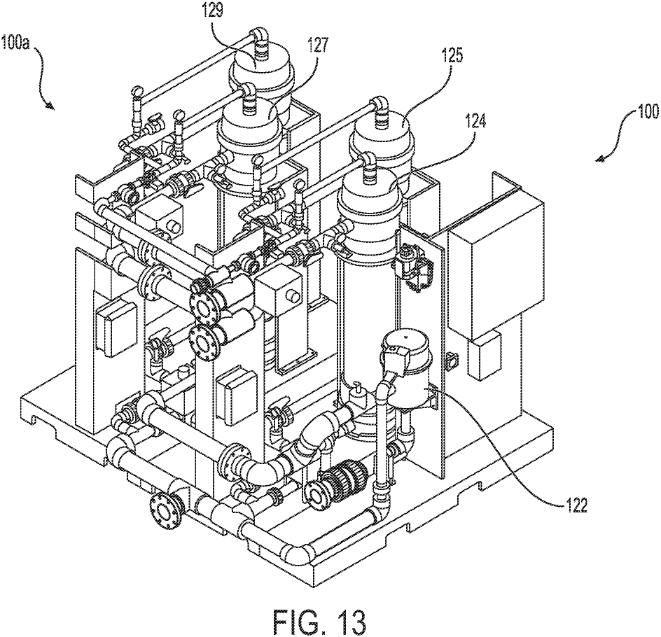

The modular nature of the modular greywater processing apparatus 100, enables multiple modular greywater processing apparatus 100 to be connected in parallel to one another so that the greywater treatment system 10 may be scaled appropriately for the needs of a particular project. For example, turning now to FIG. 13, in an alternate embodiment, a second modular greywater processing apparatus 100a may be connected in parallel to the first modular greywater processing apparatus 100. The second modular greywater processing apparatus 100a comprises a third UF filter 127 connected in parallel to a fourth UF filter 129, and both the third UF filter 127 and the fourth UF filter 129 are connected in series to the mechanical filter 122.

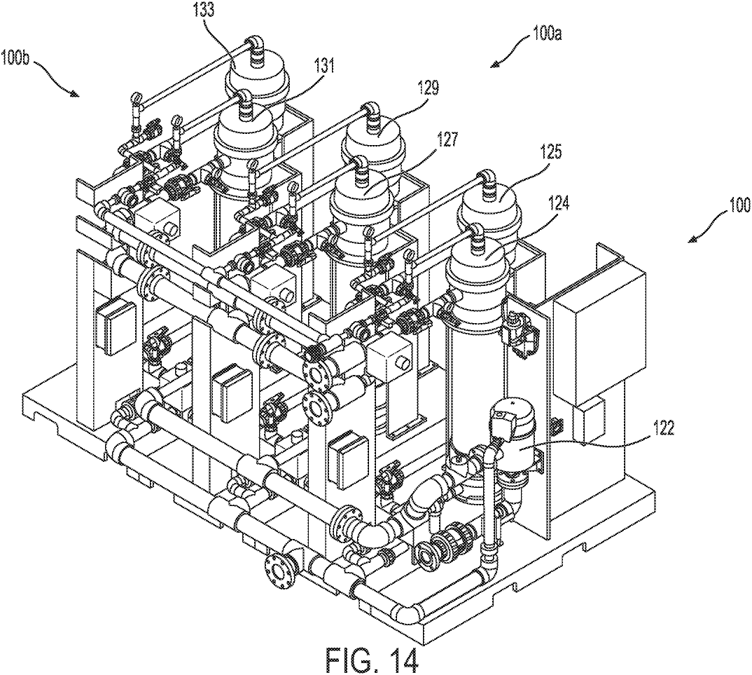

Turning now to FIG. 14, in another alternate embodiment, a third modular greywater processing apparatus 100b may be connected in parallel to the first modular greywater processing apparatus 100 and to the second modular greywater processing apparatus 100a. The third modular greywater processing apparatus 101b comprises a fifth UF filter 131 connected in parallel to a sixth UF filter 133, and both the fifth UF filter 131 and the sixth UF filter 133 are connected in series to the mechanical filter 122. Each modular greywater apparatus (i.e., each pair of UF filters) increases overall system capacity by approximately 70 gpm. Each modular greywater processing apparatus 100 may be pre-wired and transported to a use location separately. Once located at the use location, the modular greywater apparatus 100 may be quickly connected to one another in the field.

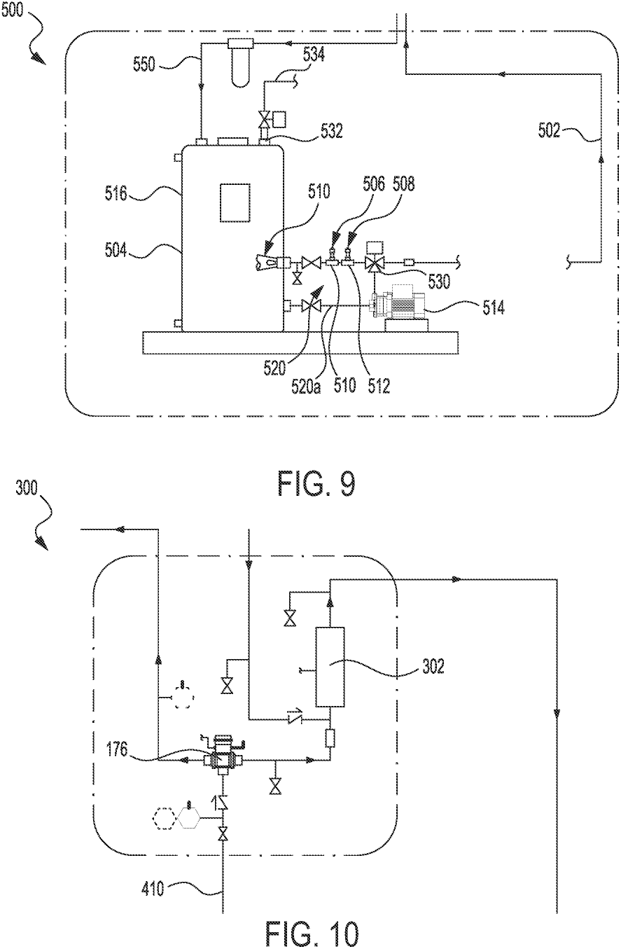

Turning now to FIG. 9, the chemical backwash unit 500 comprises a mixing tank 504 and a chemical supply. The chemical supply in the illustrated embodiment comprises a first chemical supply 506 and a second chemical supply 508. The first chemical supply 506 may be connected to a first chemical inlet 510 and the second chemical supply 508 may be connected to a second chemical inlet 512. In one embodiment, the first chemical supply 506 may comprise NaOH and the second chemical supply 508 may comprise NaOCL. In other embodiments, other chemicals may be used. The first and second chemicals are injected into the mixing tank 504 through a mixing venturi 510 downstream of the first and second chemical inlets 510, 512. More specifically, in the illustrated embodiment, a chemical backwash pump 514 circulates a chemical backwash fluid from the mixing tank 504, which may also be referred to as a chemical backwash tank 516, through a circuit 520. As the chemical backwash fluid circulates in the circuit 520, the first and second chemicals are added to the circuit 520 through the first chemical inlet 510 and the second chemical inlet 512. Chemicals are added and the chemical backwash fluid is circulated until a desired concentration of the first and second chemicals is reached in the chemical backwash fluid in the chemical backwash tank 516. The circuit 520 is controlled by a chemical backwash control valve 530. When the chemical backwash cycle is activated, the chemical backwash control valve 530 moves to direct the chemical backwash fluid from the chemical backwash tank 516, through a first branch 520a of the circuit 520 and into the cleaning line 502 for delivery to the UF filter 124. The chemical backwash tank 516 derives make up water from the processed water holding tank 400 through a processed water makeup line 534 that empties into a processed greywater inlet 532.

### Normal Operation

Returning now to FIG. 6, during normal operation, raw greywater is pumped from the raw greywater holding tank 204 to the modular greywater processing apparatus 100 at a rate of between 30 and 220 gpm at approximately 40-65 PSI, through the raw greywater output line 208. The raw greywater enters the MTF filter 122, where it passes through a 200 micron screen. The MTF filter 122 removes large particles, such as hair, lint, and larger debris. From the MTF filter 122, the greywater enters the UF filter 124 through the raw greywater inlet 120. After exiting the UF filter 124, the filtered greywater is delivered to the UV sterilizer 302 through the filtrate line 162. After exiting the UV sterilizer 302, the sterilized greywater is delivered to the processed water holding tank 400 through a processed water line 330. During normal operation, the first backwash valve 170 is open and the first control valve 172 is in a process position, allowing greywater to flow from the MTF filter 122 to the UF filter 124. The second control valve 174 is in a process position, allowing the filtered greywater to flow from the UF filter 124 to the UV sterilizer 302, and the third control valve 176 is in a process position, allowing the filtered greywater to flow from the UF filter 124 to the UV sterilizer 302.

### Standard Backwash Cycle

As discussed above, the standard backwash cycle is initiated after about 1000-3000 gallons, preferably between about 1500 and about 2500 gallons, and more preferably between about 1500-2000 gallons of greywater have been processed by the UF filter 124. Greywater flow through the UF filter 124 is monitored by a flow transmitter 180 connected to the filtrate line 162. The standard backwash cycle keeps the membranes in the UF filter 124 relatively clean so that they operate at optimum levels. Operation of the greywater treatment system 10 is controlled by the controller 600 that is normally disposed on the modular greywater processing apparatus 100. Although electrical connections between the controller 600 and various components of the greywater treatment system 10 are not illustrated, where the controller 600 is discussed as communicating with a component, such as a control valve, the controller 600 is communicatively connected to that component. The communicative connections may be electrical connections, pneumatic connections, or wireless connections, or any other type of connection that allows communication between the controller 600 and the various components of the system. During the normal backwash cycle, the first backwash valve 170 is closed, preventing fluid flow between the UF filter 124 and the UV sterilizer 302 through the filtrate line 162, the first control valve 172 is in a drain position, which allows backwash fluid (which is taken from the processed water holding tank 400) to flow out of the UF filter 124 through the raw greywater inlet 120 to a sewer (or to the raw greywater holding tank 202), and the second control valve 174 and the third control valve are in a normal backwash position, which allows backwash fluid to flow from the processed water holding tank 402 through the backwash line 410 to the filtrate outlet 128 so that the UF filter 124 is backwashed. The normal backwash cycle is between approximately 30 and 120 seconds long, preferably between 40 and 100 seconds long, more preferably approximately 45 seconds long. In some embodiments, the length of the backwash cycle may be adjustable to account for differing cleaning requirements.

### Chemical Backwash Cycle

The chemical backwash cycle is activated after between approximately 30,000 gallons and 100,000 gallons, preferably between about 30,000 and 50,000, and more preferably about 40,000 gallons, of greywater have been processed by the UF filter 124. Similar to the normal backwash cycle, greywater flow through the UF filter 124 is monitored by the flow transmitter 180. The purpose of the chemical backwash is to circulate a high pH solution of NaOCL and NaOH the UF Filter 124 to remove scale and/or to kill any biological agents that may have collected on the UF filter 124 membranes. The chemical backwash cycle lasts between 4 and 10 minutes, preferably between 4 and 8 minutes, and more preferably about 5 minutes. During the chemical backwash cycle, the chemical backwash pump 514 is activated to pump chemical backwash solution from the chemical backwash tank 516 through the chemical backwash line 502. The first backwash valve 170 is closed, the first control valve 172 is in a chemical backwash position in which chemical backwash fluid is directed from the chemical backwash line 502 into the raw greywater inlet 120. The second control valve 174 is in a chemical backwash position in which chemical backwash fluid is directed from the filtrate outlet 128 to the chemical backwash tank 516 through a chemical backwash return line 550. The raw greywater pump 206 and the processed backwash pump 408 are off during the chemical backwash cycle.

After the chemical backwash cycle is complete, a standard backwash cycle is activated, as outlined above, to remove any traces of the chemical backwash fluid from the UF filter 124 and the flow lines.

### Automatic Shutdown

As described above, the modular greywater processing apparatus 100 must be properly shutdown after use so that any remaining greywater inside the filters and piping doesn’t become blackwater. There are two ways to initiate a full system shutdown. First, the full system shutdown may be manually initiated by a button on a control touchscreen that will start an automatic shutdown sequence. Second, if the flow sensor 180 that monitors the volume of processed water does not see any change over a programmable time period (typically set to 18 hours), the system will automatically force a shutdown sequence if the shutdown push button had not been previously manually activated.

In either shutdown instance, the system performs a standard backwash of both the MTF Filter 122 and the UF Filter 124. Additionally, a drain pump 220 on the raw greywater tank 204 may be activated to empty the raw greywater holding tank 202 to a sanitary sewer at least once per every 24 hours. The automatic shutdown sequence is based on a zero flow reading from the flow sensor 180 for a minimum period of time, such as every 18 hours. In some embodiments, the minimum period of time is between 16 and 24 hours.

The disclosed greywater treatment systems have been tested to advantageously produce excellent water quality, which meets or exceeds the NSF 350 standards as listed below in table 1. In most cases, turbidity will be less than 0.5 NTU with 0 levels of E.coli and CBOD and crystal clear water with less than 1 ppm of Total Suspended Solids. Turbidity is measured at various locations throughout the system, for example in the filtrate line 162.

TABLE 1

NSF/ANSI 350 STANDARD

| | MAX | AVG |
|---|---|---|
| Turbidity | 5 | 2 |
| TSS | 30 | 10 |
| CBOD | 25 | 10 |
| E. coli | 200 | 2.2 |
| Odor | Non-Offensive | |
| pH | 6.0-9.0 | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Moreover, any dimension disclosed in one embodiment is equally applicable in other embodiments.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A greywater treatment system comprising:
a first modular greywater processing apparatus including;
a raw greywater inlet;
a mechanical (MTF) filter connected to the raw greywater inlet;
a first UF filter connected in series downstream of the mechanical filter, the UF filter including a UF filter inlet, a filtrate outlet, and a cross-flow outlet, the filtrate outlet being connected to a processed water outlet; and
a modular base supporting the mechanical filter and the UF filter.

2. The greywater treatment system of claim 1, further comprising:
a second UF filter connected in parallel with first UF filter and in series with mechanical filter.

3. The greywater treatment system of claim 1, wherein the mechanical filter filters out particulate matter 200 microns or larger.

4. The greywater treatment system of claim 3, wherein the mechanical filter includes a backwash outlet that is adapted to be fluidly connected to a sewer.

5. The greywater treatment system of claim 3, further comprising a differential pressure monitor connected to the mechanical filter.

6. The greywater treatment system of claim 1, further comprising a first control valve disposed between mechanical filter and the UF filter.

7. The greywater treatment system of claim 1, wherein the filtrate outlet is fluidly connected to a processed water holding tank.

8. The greywater treatment system of claim 1, wherein the cross-flow outlet is fluidly connected to a raw greywater tank.

9. The greywater treatment system of claim 1, further comprising a UV treatment apparatus disposed downstream of the UF filter.

10. The greywater treatment system of claim 9, further comprising a backwash line disposed between the UV treatment apparatus and the UF filter.

11. The greywater treatment system of claim 1, wherein the UF filter removes particulates 0.02 microns and larger.

12. The greywater treatment system of claim 1, further comprising a first backwash valve downstream of the UF filtrate outlet.

13. The greywater treatment system of claim 1, further comprising a second control valve disposed downstream of the UF filtrate outlet.

14. The greywater treatment system of claim 13, further comprising a third control valve between a UV treatment apparatus and the UF filtrate outlet.

15. The greywater treatment system of claim 1, further comprising a second modular greywater processing apparatus.

16. The greywater treatment system of claim 15, wherein the second modular greywater processing apparatus comprises a third UF filter connected in parallel to a fourth UF filter, both the third UF filter and the fourth UF filter being connected in series to the mechanical filter.

17. The greywater treatment system of claim 15, further comprising a third modular greywater processing apparatus.

18. The greywater treatment system of claim 17, wherein the third modular greywater processing apparatus comprises a fifth UF filter connected in parallel to a sixth UF filter, both the fifth UF filter and the sixth UF filter being connected in series to the mechanical filter.

19. The greywater treatment system of claim 1, further comprising a chemical backwash system fluidly connected to the UF filter.

20. The greywater treatment system of claim 19, wherein the chemical backwash system comprises a mixing tank and a chemical supply.

21. The greywater treatment system of claim 20, wherein the chemical backwash system further comprises a mixing venturi.

22. The greywater treatment system of claim 21, wherein the mixing tank comprises a processed greywater inlet.

23. A method of operating the greywater treatment system of claim 1, the method comprising:
backwashing the MTF filter and the UF filter based on an approximately zero flow reading from a flow sensor for a minimum period of time; and
emptying raw greywater from a raw greywater tank.

24. The method of claim 23, wherein the minimum period of time is between 16 and 24 hours, preferably about 18 hours.

25. The method of claim 23, wherein the flow sensor is disposed downstream of the UF filter.

26. The method of claim 23, further comprising continuously cleaning the UF filter with a crossflow circuit and returning the waste from the crossflow circuit to the raw greywater tank.

27. The method of claim 23, further comprising backwashing the UF filter based on a minimum flow input from the flow sensor.

28. The method of claim 27, wherein the minimum flow reading is between 1000 gallons of processed water and 3000 gallons of processed water, preferably between 1500 gallons of processed water and 2500 gallons of processed water, and more preferably at approximately 2000 gallons of processed water.

29. The method of claim 23, further comprising backwashing the MTF filter based on one of a maximum differential pressure input from a pressure sensor and a minimum flow input from the flow sensor.

30. The method of claim 29, wherein the maximum differential pressure is between 0 psi and 10 psi.

31. The method of claim 29, wherein the minimum flow input is between 35 gpm and 80 gpm.

32. The method of claim 23, further comprising chemically backwashing the UF filter with a high pH solution based on a minimum flow input from the flow sensor.

33. The method of claim 32, wherein the minimum flow input is between 30,000 gallons of processed water and 50,000 gallons of processed water, preferably about 40,000 gallons of processed water.

34. The method of claim 33, further comprising completing a clean water backwash after the chemical backwash.
